(19) United States
(12) Patent Application Publication
(10) Pub. No.: US 2023/0351992 A1
(43) Pub. Date: Nov. 2, 2023

(54) KEYBOARD INSTRUMENT

(71) Applicant: CASIO COMPUTER CO., LTD., Tokyo (JP)

(72) Inventor: Yasushi SHIRAISHI, Tokyo (JP)

(73) Assignee: CASIO COMPUTER CO., LTD., Tokyo (JP)

(21) Appl. No.: 18/305,236

(22) Filed: Apr. 21, 2023

(30) Foreign Application Priority Data
Apr. 28, 2022 (JP) 2022-074163

(51) Int. Cl. G10H 1/34

(52) U.S. Cl. CPC G10H 1/346; G10H 2220/221; G10H 2220/265

(57) ABSTRACT

The keyboard instrument includes mounting members (a first member and a second member) and a key base member 300 in which the mounting members are mounted on side surfaces. On the lower side of the side surfaces, there are lower groove portions that cannot be visually recognized from the outside when the mounting members are attached.

### BACKGROUND OF THE INVENTION

### Technical Field

The present invention relates to keyboard instruments.

### Background Art

Conventionally, there has been proposed a keyboard instrument having keys in which a mounting member made of a wooden member, a wood-grain member, or the like is attached to a key base member with an adhesive. For example, a key is disclosed in which a mounting member is fitted into a concave portion formed on the side surface of a key base member made of resin. The mounting member is attached to the key base member by gluing.

### RELATED ART DOCUMENT

### Patent Document

Patent Document 1: Japanese Patent Application Laid-Open Publication No. 2006-163444

When the mounting member is attached to the key base member with an adhesive, the adhesive may protrude to the outside, contaminating the surroundings, or the adhesive may stick to the key, resulting in an unappealing key. Also, if the amount of adhesive used is reduced in order to prevent the adhesive from oozing out, the mounting member may not adhere well and may come off from the key base member.

An advantage of the present invention is to provide a keyboard instrument having keys in which mounting members are satisfactorily attached to key base members while reducing adhesive run-out.

### SUMMARY OF THE INVENTION

Features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a keyboard instrument, comprising a plurality of keys, wherein each key includes a mounting member and a key base member to which the mounting member is attached on a side surface thereof, and wherein the key base member has, on a lower side of the side surface, a lower groove portion that cannot be seen from the outside when the mounting member is attached thereto.

According to the present invention, it is possible to provide a keyboard instrument having keys in which the mounting member is satisfactorily attached to the key base member while reducing the protrusion of the adhesive used to attach the mounting member to the key base member.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a perspective view showing a keyboard instrument according to an embodiment of the invention.

FIG. 2 is a cross-sectional view taken along line II-II of FIG. 1 of the keyboard instrument according to the embodiment of the present invention. Sides of white and black keys are shown.

FIG. 3 is an exploded perspective view showing the white key of the C key of the keyboard instrument according to the embodiment of the present invention.

FIG. 4 is a left side view of the key base member of the C key of the keyboard instrument according to the embodiment of the present invention.

FIG. 5 is a right side view of the key base member in the C key of the keyboard instrument according to the embodiment of the present invention.

FIG. 6 is a VI-VI cross-sectional view of FIG. 4 of the white key of the keyboard instrument according to the embodiment of the present invention.

FIG. 7 is a VII-VII cross-sectional view of FIG. 4 of the white key of the keyboard instrument according to the embodiment of the present invention.

FIG. 8 is a VIII-VIII cross-sectional view of FIG. 4 of the white key of the keyboard instrument according to the embodiment of the present invention.

FIG. 9 is a IX-IX cross-sectional view of FIG. 4 of the white key of the keyboard instrument according to the embodiment of the present invention.

FIG. 10 is a X-X cross-sectional view of FIG. 4 of the white key of the keyboard instrument according to the embodiment of the present invention.

FIGS. 11A-11B are schematic cross-sectional views showing a process of attaching a mounting member (firs/second member) to a white key of the keyboard instrument according to the embodiment of the present invention. FIG. 1A shows a state before attaching the mounting member in which the adhesive is applied to the side plate, and FIG. 1B shows a state in which the mounting member is attached to the side plate.

### DETAILED DESCRIPTION OF EMBODIMENTS

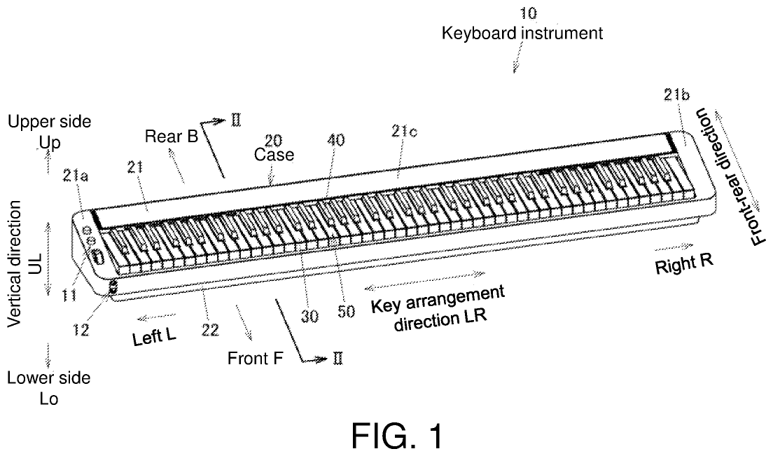

Hereinafter, embodiments of the present invention will be described with reference to the drawings. A keyboard musical instrument 10 shown in FIG. 1 includes a full-size (88 keys) keyboard 50 having a plurality of white keys 30 and a plurality of black keys 40, as a plurality of keys, and a case 20. In the following description, the front side of the keyboard 50 in the front-back direction FB is defined as the front side F, the rear side of the key in the front-back direction FB is defined as the rear side B, the left side of the keyboard 50 is defined as the left side L, and the right side is defined as the right side R. The arrangement direction LR of the keys of the keyboard 50 is the left-right direction. Also, in the vertical direction UL of the keyboard instrument 10, the upper side is Up and the lower side is Lo. Although the keyboard instrument 10 of the present embodiment is shown as an electronic piano, other keyboard instruments may be used as long as they produce sound in response to the player's (user's) pressing of keys.

The case 20 is in the shape of a substantially long rectangular plate whose longitudinal direction is the horizontal direction, and is divided into an upper case 21 and a lower case 22. The upper case 21 and the lower case 22 are each made of a resin material. Inside the case 20, a board, a battery as a power supply, and the like are accommodated. An operation unit 11 having knobs and dials for volume and various settings is provided on the upper surface on the left side of the upper case 21. An earphone jack 12 is provided on the left front surface of the upper case 21.

An upper surface 21a of the upper case 21 adjacent to the keyboard 50 on the left side of the upper case 21 and an upper surface 21b of the upper case 21 adjacent to the keyboard 50 on the right side are inclined surfaces extending from the rear to the front. In addition, the upper surface 21c that is long in the left and right direction provided at the upper center of the upper case 21 is also formed as an inclined surface. Also, although not shown, the rear surface of the upper case 21 is provided with a hole corresponding to a speaker.

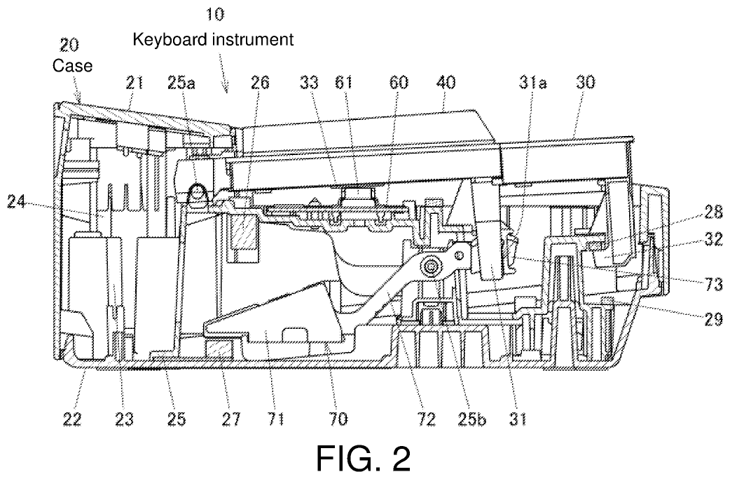

As shown in FIG. 2, the case 20 has a lower boss portion 23 erected from the lower case 22 and an upper boss portion 24 erected from the upper case 21, which are screwed together by bolts so as to couple the upper case 21 and the lower case 22. An inner case 25 is provided inside the case 20. The inner case 25 is elongated in the key arrangement direction LR, and has a substantially U-shaped cross section with the opening side facing the lower side Lo in the cross-sectional view of FIG. 2. A circuit board 60 is provided on the upper surface of the inner case 25. A plurality of switches 61 are provided on the circuit board 60 so as to correspond to respective white keys 30 and respective black keys 40. Each white key 30 and each black key 40 has a switch pressing portion 33 (FIG. 2 shows the switch pressing portion 33 of the white key 30, and the switch pressing portion of the black key 40 is not shown) at a position corresponding to the switch 61.

A support shaft 25a for rotatably supporting each white key 30 and each black key 40 is provided at a rear portion of the inner case 25 so as to correspond to each white key 30 and each black key 40. A hammer member 70 is provided in the inner case 25 for each of the white keys 30 and the black keys 40. A weight portion 71 is provided on the rear side B of the hammer member 70. An arm portion 72 extending from the weight portion 71 to the front side F is rotatably supported by a support shaft 25b provided in the inner case 25. At the tip of the arm 72, a hammer cap 73 is provided so as to be coupled with a hammer pressing portion 31 extending downward Lo from the corresponding white key 30 or black key 40 (FIG. 2 shows the hammer pressing portion 31 of the white key 30, and the hammer pressing portion of the black key 40 is not shown). The hammer pressing portion 31 is provided with a hole portion 31a with which the hammer cap 73 is coupled. Further, each white key 30 and each black key 40 has a hook-shaped regulating projection 32 (FIG. 2 shows the regulating projection 32 of the white key 30, not shown for the black key 40).

Using the white key 30 as an example, the operation of the white key 30 and the hammer member 70 will be described. When the white key 30 is pressed, the hammer pressing portion 31 of the white key 30 presses down the hammer cap 73. Then, the weight portion 71 of the hammer member 70, which is opposite to the hammer cap 73 with the support shaft 25b interposed therebetween, rises. In this way, the white keys 30 can be pressed while feeling the weight similar to that of a real piano. The lifted weight portion 71 abuts on the upper cushion 26 for the hammer provided in the inner case 25.

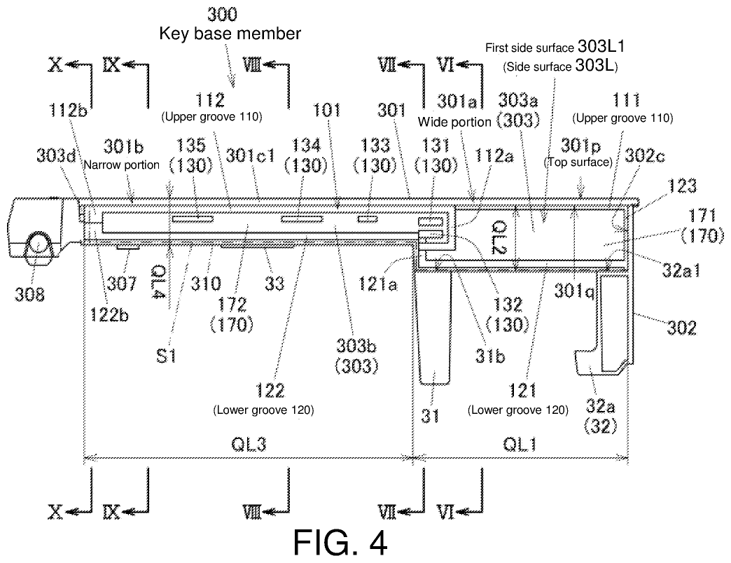

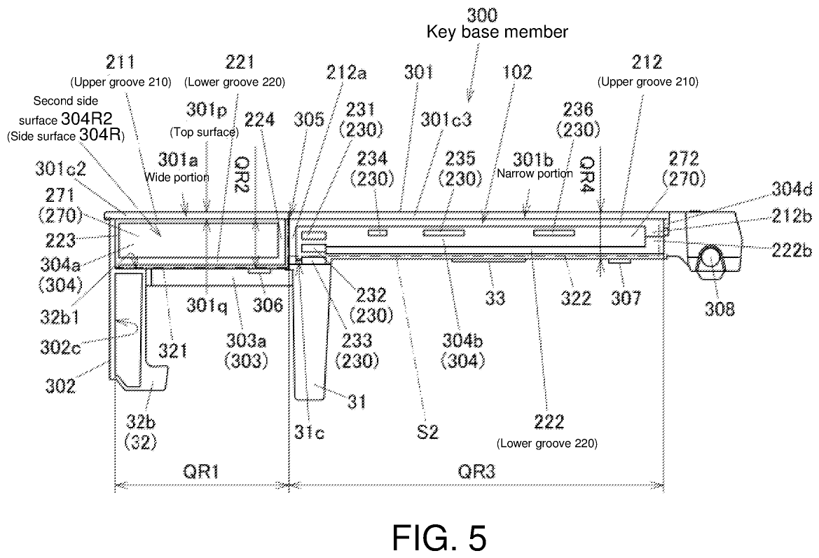

On the other hand, when the white key 30 is pressed, the restricting protrusion 32 is pressed down and comes into contact with a lower cushion 29 provided corresponding to the restricting protrusion 32. When the white key 30 is pressed, the switch 61 is pressed by a switch pressing portion 33 provided in the white key 30, and the sound corresponding to the pressed white key 30 is produced. Then, when the white key 30 is released, the weight portion 71 of the hammer member 70 descends and abuts a lower cushion 27, and the jaw portion of the regulating projection 32 abuts an upper cushion 28, resulting in the state shown in FIG. 2. As shown in FIGS. 4 and 5, the restricting protrusion 32 is composed of a plate-like left restricting protrusion 32a and a plate-like right restricting protrusion 32b.

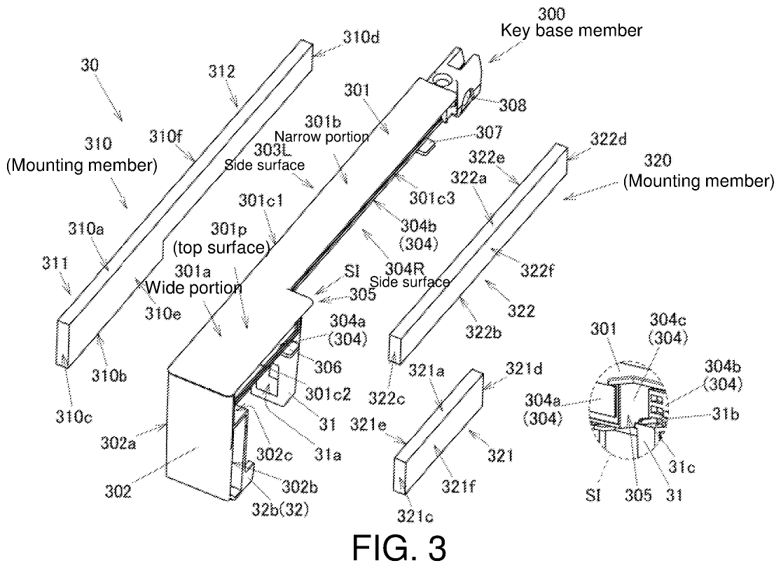

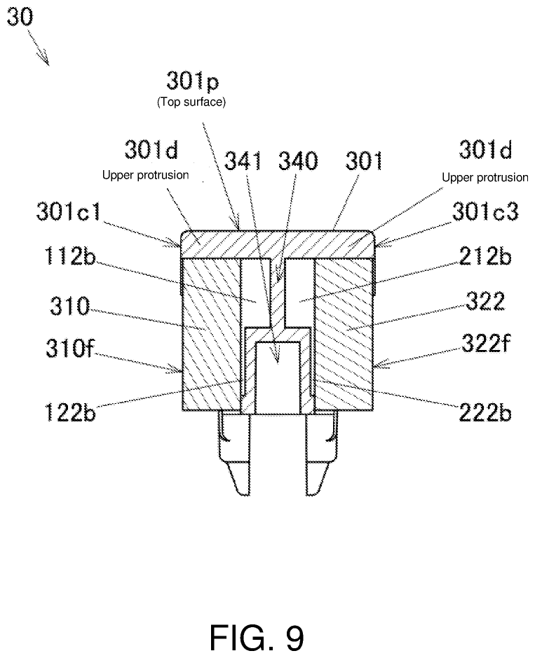

In the following, the white key 30, which is the C key corresponding to the C scale, will be described as an example with reference to FIGS. 3 to 10. As shown in FIG. 3, the white key 30 includes mounting members (first member 310 and second member 320) and a key base member 300. The mounting member is made of a wooden member or a wood grain member. The key base member 300 is manufactured by injection molding of resin. The key base member 300 is provided with the aforementioned hammer pressing portion 31, the restricting projection 32, and the switch pressing portion 33. A stepped portion 305 is provided on the right side R of the key base member 300. The rear side of the stepped portion 305 is a narrow portion arranged adjacent to the black key 40, and the front side of the stepped portion 305 is a wide portion having a key pressing surface.

The key base member 300 includes a top plate 301 having an upper surface 301p and a lower surface 301q. The top plate 301 includes a wide portion 301a forward of the stepped portion 305 and a narrow portion 301b rearward of the stepped portion 305. In other words, the key base member 300 has the wide portion 301a having a first width in the key arrangement direction LR on the top surface (upper surface 301p) and the narrow portion 301b having a second width narrower than the first width. A front plate 302 extending downward to the lower side Lo is provided from the lower surface 301q (see FIGS. 4 and 5) of the front end portion of the top plate 301. The front plate 302 is arranged with its plate surface facing the front-rear direction FB, and is provided with the same width as the wide portion 301a of the top plate 301.

Further, the key base member 300 is provided with left and right side plates 303 and 304 that are connected to the bottom surface 301q of the top plate 301 and the rear surface 302c of the front plate 302. A first member 310 as a mounting member is arranged on the side surface 303L of the side plate 303, and a second member 320 as a mounting member is attached to the side surface 304R of the side plate 304.

The first member 310 is provided in a plate shape having an outer shape corresponding to the side plate 303 (side surface 303L) on which it is arranged. The first member 310 has a front portion 311 and a rear portion 312, and the front portion 311 and the rear portion 312 are provided continuously. The length of the front portion 311 in the vertical direction UL is longer than the length of the rear portion 312 in the vertical direction UL. An upper surface 310a of the first member 310 is a continuous surface, and the lower surface 310b is stepped at the connecting portion between the front portion 311 and the rear portion 312.

The second member 320 is provided in a plate shape having an outer shape corresponding to the side plate 304 (side surface 304R) on which it is arranged. The second member 320 includes a substantially rectangular plate-like front second member 321 that is long in the front-rear direction FB, and a substantially rectangular plate-like rear second member 322 that is long in the front-rear direction FB. The length of the front second member 321 in the vertical direction UL is longer than the length of the rear second member 322 in the vertical direction UL.

As shown in FIGS. 3 and 4, the first member 310 is arranged on the side plate 303 (side surface 303L) of the key base member 300 such that the front surface 310c is in contact with the rear surface 302c of the front plate 302 of the key base member 300, the upper surface 310a is in contact with the lower surface 301q of the top plate 301, and the side surface 301e is in contact with a contact surface 170, which is described later.

As shown in FIGS. 3 and 5, the front second member 321 of the second member 320 is arranged on the side surface (which will be described later) of a front side plate 304a of the side plate 304 (side surface 304R) of the key base member 300 such that a front surface 321c is in contact with the rear surface 302c of the front plate 302 of the key base member 300, an upper surface 321a is in contact with the lower surface 301q of the top plate 301, and the side surface 321e is in contact with the front contact surface 271 of the contact surface 270, which will be described later.

Similarly, the rear second member 322 of the second member 320 is arranged on the side surface (will be described later) of the rear side plate 304b of the side plate 304 (side surface 304R) of the key base member 300 such that a front surface 322c is in contact with the connection plate 304c, an upper surface 322a is in contact with the lower surface 301q of the top plate 301, and a side surface 322e is in contact with a rear contact surface 272 of a contact surface 270 described later.

Note that the rear surface 310d of the first member 310 does not abut against a wall portion 303d (described later), which stands on the rear end of the side plate 303 and faces the rear surface 310d, and a gap is provided therebetween. A rear surface 322d of the rear second member 322 of the second member 320 does not abut against a wall portion 304d (described later), which stands on the rear end of the side plate 304 and faces the rear surface 322d, and a gap is provided therebetween. Also, the rear surface 321d of the front second member 321 of the second member 320 is left open.

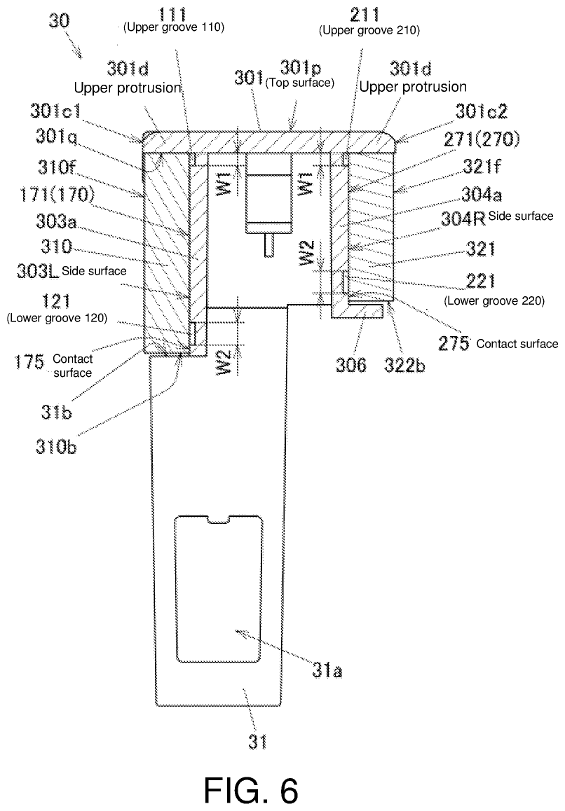

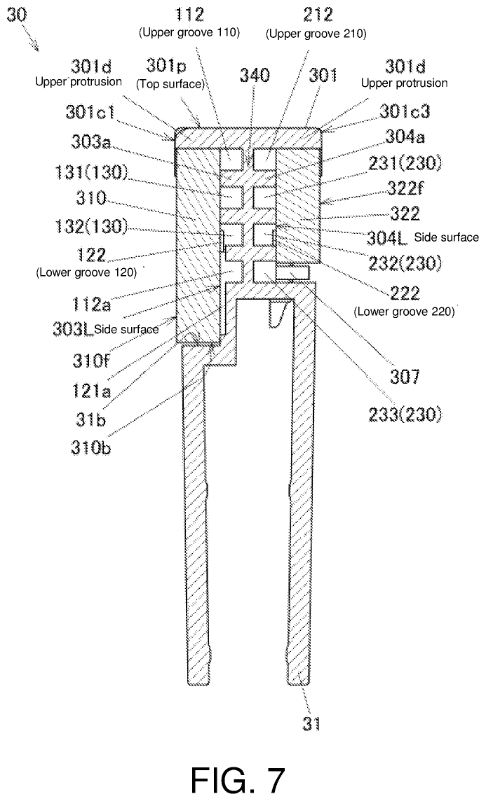

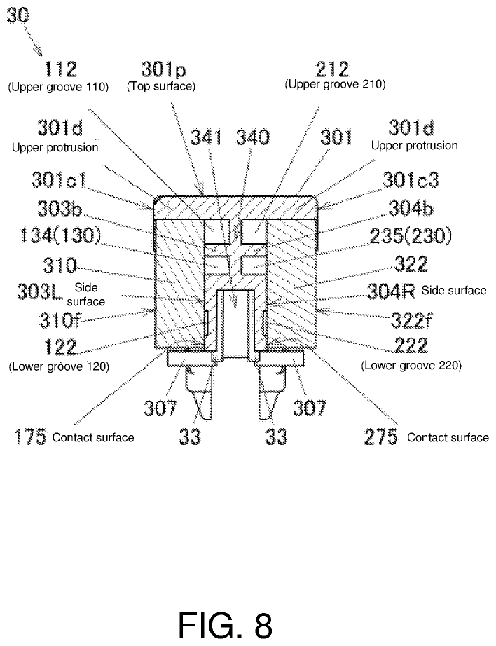

Further, as shown in FIG. 6, the side plate 303 is provided at a position where the left side L side edge 301c1 of the top plate 301 and the outer side surface 310f of the first member 310 are substantially flush with each other Similarly, the side plates 304 (the front side plate 304a and the rear side plate 304b (see FIGS. 7 and 8)) are positioned such that the side ends 301c2 and 301c3 and the outer side surfaces 321f and 322f of the second member 320 are substantially flush with each other. The top plate 301 projects from the side surfaces 303L, 304R of the side plates 303, 304 to the left side L and the right side R in the key arrangement direction, and the upper protruding portions 301d cover the upper surfaces 310a, 321a, and 322a of the first member 310 and the second member 320, as shown in FIGS. 6 to 10.

As shown in FIG. 4, the left side plate 303 has a front plate 303a corresponding to the wide portion 301a of the top plate 301 and a rear plate 303b corresponding to the narrow portion 301b. The front side plate 303a and the rear side plate 303b each have a substantially rectangular plate shape elongated in the front-rear direction FB, and are continuously provided in a straight line (substantially flush with each other). The length QL1 in the front-rear direction FB of the front side plate 303a is set shorter than the length QL3 in the front-rear direction FB of the rear side plate 303b (QL1<QL3). The length QL2 of the front side plate 303a in the vertical direction UL is longer than the length QL4 of the rear side plate 303b in the vertical direction UL (QL2>QL4).

Within a projection area S1 of the first member 310 on the side surface 303L of the side plate 303 (that is, within a projection area S1 of the first member 310 with respect to the side plate 303, which is indicated by the outline of the first member 310 indicated by the two-dot chain line), a left groove 101 of a groove 100 that fits in the region S1 is provided. That is, the left groove 101 of the groove 100 is entirely within the projection area S1. In other words, the left groove 101 of the groove 100 cannot be visually recognized from the outside when the mounting member (first member 310) is mounted. Here, the left groove 101 includes an upper groove portion 110 on the upper side of the side surface 303L, a lower groove portion 120 on the lower side of the side surface 303L, and a connection groove portion 123.

The upper groove portion 110 having a concave cross section extends along the upper edge of the projection area S1 of the first member 310 on the side surface 303L of the side plate 303 (in other words, along the lower surface 301q of the top plate 301) in the front-rear direction FB (longitudinal direction of the key) and is provided along the longitudinal direction of the key. The upper groove portion 110 includes a front upper groove portion 111 provided corresponding to the side surface 303L (the first side surface 303L1 of the wide portion 301a) corresponding to the front side plate 303a, and a rear upper groove portion 112 connected to the rear end of the front upper groove portion 111, provided corresponding to the side surface 303L corresponding to the side plate 303b. At the front end of the rear upper groove portion 112, a substantially U-shaped portion 112a having the open side as the rear side B is provided. A substantially L-shaped portion 112b is provided at the rear end of the rear upper groove portion 112.

In addition, in the vicinity of the lower edge of the projection area S1 of the first member 310 on the side plate 303 (in other words, a position offset upward Up from the lower edge of the projection area S1), a long lower groove 120 extending in the front-back direction FB (longitudinal direction of the key) is provided along the lengthwise direction of the key. The lower groove portion 120 includes a front lower groove portion 121 provided corresponding to the side surface 303L (the first side surface 303L1 in the wide portion 301a) corresponding to the front side plate 303a, and a rear lower groove portion 122 corresponding to the side surface 303L corresponding to the rear side plate 303b. A substantially L-shaped portion 121a is provided in the front lower groove portion 121. The front lower groove portion 121 is connected to the rear lower groove portion 122 via an L-shaped portion 121a. The L-shaped portion 121a is also connected to the end of the U-shaped portion 112a of the rear upper groove portion 112. A substantially L-shaped portion 122b is provided at the rear end of the rear lower groove portion 122. The rear upper groove portion 112 and the rear lower groove portion 122 are connected to each other at the rear ends at the L-shaped portions 112b and 122b. A wall portion 303d is provided on the rear side B of the L-shaped portions 112b and 122b.

The front end of the front upper groove portion 111 of the upper groove portion 110 and the front end of the front lower groove portion 121 of the lower groove portion 120 are connected by a connection groove portion 123 provided in the vertical direction UL.

A contact surface 170 that contacts the side surface 310e of the first member 310 is provided between the upper groove portion 110 and the lower groove portion 120 in the vertical direction UL. The contact surface 170 is a flat surface. The contact surface 170 includes a front contact surface 171 provided corresponding to the front side plate 303a and a rear contact surface 172 provided corresponding to the rear side plate 303b. The front contact surface 171 is surrounded by the front upper groove portion 111, the connection groove portion 123, the front lower groove portion 121 including the L-shaped portion 121a, and the U-shaped portion 112a of the rear upper groove portion 112. The rear contact surface 172 is surrounded by the rear upper groove portion 112 including the U-shaped portion 112a and the L-shaped portion 112b, the L-shaped portion 121a, and the rear lower groove portion 122 including the L-shaped portion 122b.

Further, the rear contact surface 172 of the contact surface 170 is provided with a plurality of recesses 130 each having a substantially elongated rectangular shape elongated in the front-rear direction FB. The recesses 130 include a first recessed portion 131 and a second recessed portion 132 arranged vertically on the front side F of the rear contact surface 172, a third recessed portion 133 provided on the rear side B thereof, a fourth recessed portion 134 provided on the rear side B thereof, and a fifth recessed portion 135 provided further on the rear side B thereof.

As shown in FIGS. 3 and 5, the right R side plate 304 has a front side plate 304a corresponding to the wide portion 301a of the top plate 301 and a rear side plate 304b corresponding to the narrow portion 301b. The front side plate 304a and the rear side plate 304b are connected to each other in a stepped manner corresponding to the stepped portion 305 by a connection plate 304c oriented perpendicularly to the side plate 304 (the front side plate 304a and the rear side plate 304b). See the SI portion enclosed in FIG. 3. The length QR1 in the front-rear direction FB of the front side plate 304a is set shorter than the length QR3 in the front-rear direction FB of the rear side plate 304b (QR1<QR3). The length QR2 in the vertical direction UL of the front side plate 304a is longer than the length QR4 in the vertical direction UL of the rear side plate 304b (QR2>QR4).

As shown in FIG. 5, within the projection area S2 of the second member 320 on the side plate 304 (that is, within the projection area S2 of the second member 320 with respect to the side plate 304, which is indicated by the outline of the second member 320 indicated by the two-dot chain line) a right groove 102 of the groove 100 is provided. In other words, the right groove 102 of the groove 100 cannot be visually recognized from the outside when the mounting member (second member 320) is attached. Here, the right groove 102 includes an upper groove portion 210 on the upper side of the side surface 304R, a lower groove portion 220 on the lower side of the side surface 304R, and connecting groove portions 223 and 224. That is, the right groove 102 of the groove 100 is entirely within the projection area S2.

The upper groove portion 210 having a concave groove shape in cross section extends in the front-rear direction FB along the upper edge of the projection area S2 of the second member 320 on the side surface 304R of the side plate 304 (in other words, along the lower surface 301q of the top plate 301), and is provided along the longitudinal direction of the keys. The upper groove portion 210 includes a front upper groove portion 211 provided corresponding to the side surface 304R (a second side surface 304R2 opposite to the first side surface 303L1) corresponding to the front side plate 304a, and a rear upper groove portion 212 corresponding to the side surface 304R corresponding to the rear side plate 304b. A substantially L-shaped portion 212a extending downward is provided at the front end of the rear upper groove portion 212. A substantially L-shaped portion 212b is provided at the rear end of the rear upper groove portion 212.

In addition, in the vicinity of the lower edge of the projection area S2 of the second member 320 on the side plate 304 (in other words, a position offset upward Up from the lower edge of the projection area S2), a long lower groove portion 220 extending in the front-rear direction FB (longitudinal direction of the key) is provided along the length of the keys. The lower groove portion 220 includes a front lower groove portion 221 provided corresponding to the side surface 304R (second side surface 304R2 opposite to the first side surface 303L1) corresponding to the front side plate 304a, and a rear lower groove portion 222 corresponding to the side surface 304R corresponding to the rear side plate 304b. The front and rear end portions of the front lower groove portion 221 are connected to the front upper groove portion 211 by connection groove portions 223 and 224 provided in the vertical direction UL, respectively. A substantially L-shaped portion 222b is provided at the rear end of the rear lower groove portion 222. The rear upper groove portion 212 and the rear lower groove portion 222 are connected to each other at the rear ends at the L-shaped portions 212b and 222b. A wall portion 304d is provided on the rear side B of the L-shaped portions 212b and 222b.

A contact surface 270 that contacts the side surface of the second member 320 is provided between the upper groove portion 210 and the lower groove portion 220 in the vertical direction UL. The contact surface 270 is a flat surface. The contact surface 270 includes a front contact surface 271 provided corresponding to the front side plate 304a and a rear contact surface 272 provided corresponding to the rear side plate 304b. The front contact surface 271 is surrounded by the front upper groove portion 111, the connection groove portions 223 and 224, and the front lower groove portion 221. Also, the rear contact surface 272 is surrounded by the rear upper groove portion 212 including the L-shaped portion 212a and the rear lower groove portion 122.

Also, as shown in FIGS. 6 and 8-10, the key base member 300 has contact surfaces 175, 275 with the side surfaces 310e, 321e, 322e of the mounting members (the first member 310, the second member 320) below the lower groove portions 120, 220 on the side surfaces 303L, 304R.

In addition, the rear contact surface 272 is provided with a plurality of recesses 230 each having a substantially elongated rectangular shape elongated in the front-rear direction FB. The recesses 230 include a first recessed portion 231, a second recessed portion 232, and a third recessed portion 233, which are vertically arranged on the front side F of the rear contact surface 272, a fourth recessed portion 234 provided on the rear side B thereof, a fifth recess 235 provided on the rear side B thereof, and a sixth recess 236 provided on the rear side B thereof.

The front-rear direction FB length QL1 of the front side plate 303a of the left side L side plate 303 is longer than the front-rear direction FB length QR1 of the front side plate 304a of the right side R side plate 304 (QL1>QR1). The length QL2 in the vertical direction UL of the front side plate 303a of the left side plate 303 on the left side L is longer than the length QR2 in the vertical direction of the front side plate 304a of the side plate 304 on the right side R (QL2>QR2). Here, the front lower groove portions 121 and 221 are provided near the lower edges of the first side surface 303L1 and the second side surface 304R2, respectively. Therefore, the distance from the top surface (top surface 301p) to the lower groove portion 120 (front bottom groove portion 121) of the first side surface 303L1 is longer than the distance from the top surface (top surface 301p) to the lower groove portion 220 (front lower groove portion 221) of the second side surface 304R2; they are different.

The length QL3 in the front-rear direction FB of the rear side plate 303b of the left side plate 303 on the left side L is shorter than the length QR3 in the front-rear direction FB of the rear side plate 304b of the right side plate 304 on the right side R (QL3<QR3). The vertical UL length QL4 of the rear side plate 303b of the left L side plate 303 is substantially the same as the vertical UL length QR4 of the rear side plate 304b of the right R side plate 304 (QL4=QR4).

A plate-shaped switch pressing portion 33 protruding toward the lower side Lo is provided on the rear side plates 303b and 304b of the side plates 303 and 304 corresponding to the narrow portion 301b. A projecting plate 306 projecting to the right R is provided on the lower surface of the side plate 304 corresponding to the wide portion 301a. Similarly, the lower surfaces of the side plates 303 and 304 corresponding to the narrow portion 301b are provided with protruding plates 307 protruding in the left-right direction.

As shown in FIG. 6, in the side plates 303, 304, the width W1 of the front upper groove portions 111, 211 of the upper groove portions 110, 210 in the vertical direction UL is narrower than the width W2 in the vertical direction UL of the front lower groove portions 121, 221 of the lower groove portions 120, 220. The depth of the front upper groove portions 111 and 211 in the key arrangement direction LR is the same as the depth of the front lower groove portions 121 and 221 in the key arrangement direction LR. Therefore, the volume of the front lower groove portions 121 and 221 is larger than the volume of the front upper groove portions 111 and 211. Thus, grooves 100 include portions of different widths and equal depths.

As shown in FIG. 7, in the side plates 303, 304, a plurality of recesses 130, 230 are provided at the connecting portions of the front side plates 303a, 304a and the rear side plates 303b, 304b. Further, the depth of the recesses 130, 230 and the groove depth of the rear upper groove portions 112, 212 are substantially the same. The rear side plates 303b and 304b are joined together, and a solid portion 340 having a solid interior is provided by the rear side plates 303b and 304b. The recesses 130, 230 are provided on the contact surfaces 170, 270 (rear contact surfaces 172, 272) to which the first member 310, the second member 320 and the side plates 303, 304 contact within the projection regions S1, S2, corresponding to the solid portion 340.

The left restricting protrusion 32a of the restricting protrusion 32 shown in FIG. 4 is provided with an upper surface 32a1 that faces the lower surface 310b of the front portion 311 of the first member 310. Similarly, as shown in FIGS. 4, 6 and 7, the hammer pressing portion 31 is provided with an upper surface 31b facing the lower surface 310b of the front portion 311 of the first member 310. A predetermined gap is provided between the upper surfaces 32a1 and 31b and the lower surface 310b of the front portion 311 of the first member 310. The upper surface 32a1 of the left restricting projection 32a on the left side L and the upper surface 31b of the hammer pressing portion 31 on the left side L are arranged substantially on the same plane.

In addition, the upper surface of the projection plate 306 on the right side R and the upper surface 32b1 of the right restricting projection 32b on the right side R are arranged substantially on the same plane. Further, the upper surface of the protrusion 31c protruding from the upper surface of the right R hammer pressing portion 31 and the upper surface of the right R protrusion plate 307 are arranged substantially on the same plane. A predetermined gap is also provided between the upper surface of the protrusion 31c and the protrusion plate 307 and the lower surface 322b of the rear second member 322.

The upper surface 32a1 of the left restricting projection 32a, the upper surface 31b of the hammer pressing portion 31, the projection 31c, and the projecting plates 306 and 307, which are provided, respectively, at locations corresponding to lower surfaces 310b, 321b, 322b of mounting members (first member 310, second member 320), are mounting member receiving portions that receive the first member 310 and the second member 320 in the event that the first member 310 and the second member 320 are displaced to the lower side Lo. It should be noted that the lower surfaces 310b, 321b, 322b of the first member 310 and the second member 320 do not have opposing surfaces or members, and therefore, are left open at portions other than the mounting member receiving portion.

A rotation hole 308 rotatably engaged with the support shaft 25a of the inner case 25 inside the case 20 is provided at the rear end of the key base member 300 so as to pass through in the key arrangement direction LR.

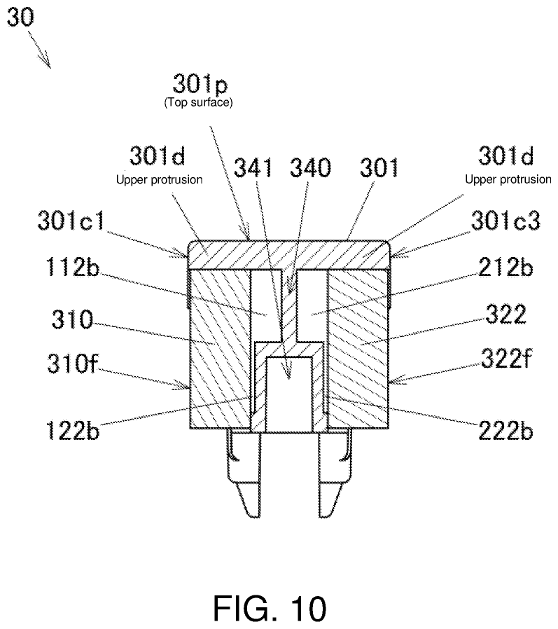

As shown in FIG. 8, the key base member 300 is provided with an inverse U-shaped bifurcated portion 341 via the solid portion 340 that is formed by combining the rear side plates 303b and 304b from the lower surface 301q of the top plate 301. The rear upper groove portions 112, 212 and the rear lower groove portions 122, 222 have the same width. The depth of the rear upper groove portions 112, 212 is deeper than the depth of the rear lower groove portions 122, 222, and is substantially the same as the depth of the recess 130. As shown in FIG. 8, the switch pressing portion 33 is provided at the tips of the bifurcated portion 341. As shown in FIG. 10, the L-shaped portions 112b, 212b of the deep rear upper groove portions 112, 212 are provided corresponding to the solid portion 340, and are deeper than the rear upper groove portions 112, 212. The L-shaped portions 122b and 222b of the rear lower groove portions 122 and 222 that are shallower than the rear upper groove portions 112, 212 are provided corresponding to the bifurcated portion 341.

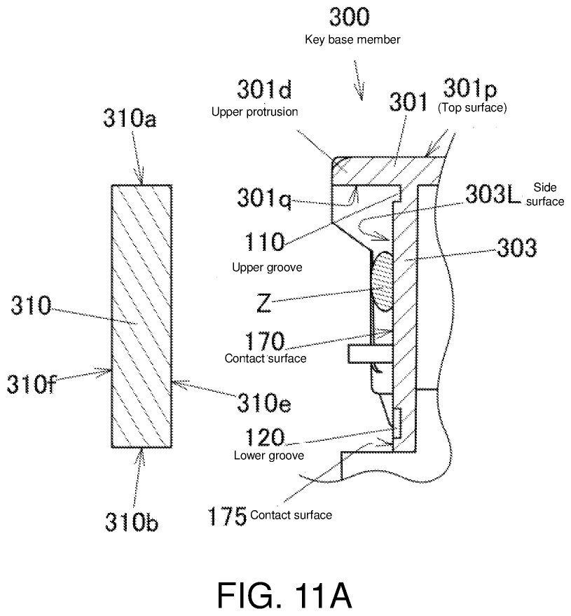

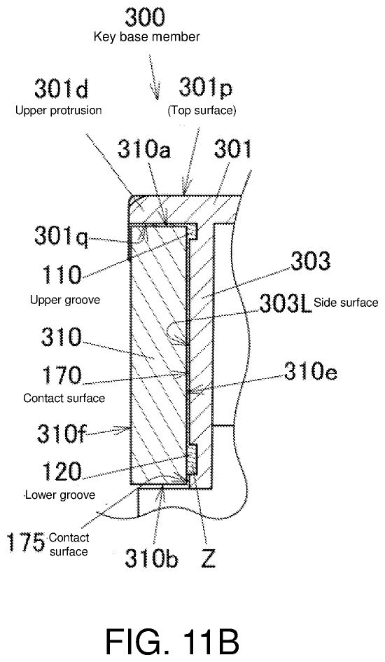

A method of mounting the first member 310 (front portion 311) and the second member 320 (front second member 321) to the key base member 300 (the front contact surfaces 171 and 271 of the contact surfaces 170 and 270 of the front side plates 303a and 304a, respectively) is explained with reference to FIGS. 11A and 11B, which schematically show the first member 310, the side plate 303, the upper groove portion 110 and the lower groove portion 120 having the same depth but different widths, the contact surface 170, and the contact surface 175.

First, as shown in FIG. 11A, an adhesive Z is provided on the contact surface 170 of the side surface 303L of the side plate 303. Then, as shown in FIG. 11B, the side surface 310e of the first member 310 is brought into close contact with the contact surface 170 by bringing the upper surface 310a and the lower surface 301q of the upper protruding portion 301d (the top plate 301) into sliding contact with each other. Then, the adhesive Z flows to the upper side Up and the lower side Lo.

As for the adhesive Z that has flowed to the upper side Up, excess adhesive Z is stored in the upper groove portion 110. Since the upper groove portion 110 is provided along the lower surface 301q of the upper protruding portion 301d, the adhesive Z that was not stored in the upper groove portion 110 enters the gap between the upper surface 310a of the first member 310 and the lower surface 301q of the upper protruding portion 301d, which are in sliding contact with each other. The adhesive Z that has entered the gap between the upper surface 310a and the lower surface 301q hardly comes out from the gap or stops in the middle of the gap without substantially leaking to the outside.

On the other hand, the adhesive Z that has flowed to the lower side Lo is stored in the lower groove portion 120 because the groove width W2 is sufficiently wide (the volume of the lower groove portion 120 is larger than that of the upper groove portion 110). Therefore, leakage does not occur to the lower surface 310b side of the first member 310 via the contact surface 175. Therefore, the leaked adhesive does not adhere to the circuit board 60 provided below the white key 30 and other components. Here, in FIG. 11B, since the adhesive Z is schematically illustrated as having a thickness, the contact surface 175 and the side surface 310e appear to be separated from each other, but they are actually in contact with each other.

Similarly, for each of the white keys 30 other than this C key, the side plate of the white key 30 having the stepped portion 305 is provided with a groove 100 similar to the right groove 102 of the C key. The side plate of the white key 30 having no stepped portion 305 is provided with a groove 100 similar to the left groove 101 of the C key. Moreover, the top plate 301, the front plate 302, and the side plates 303 and 304 may be block-shaped instead of plate-shaped.

As described above, in the embodiment of the present invention, the keyboard instrument 10 includes the mounting members (the first member 310 and the second member 320), and the key base member 300 in which the mounting members are attached on the side surfaces 303L and 304R. The key base member 300 has lower groove portions 120 and 220 which are not visible from the outside when the mounting members are attached on the lower sides of the side surfaces 303L and 304R.

As a result, even if the first member 310 and the second member 320 are attached using a sufficient amount of adhesive, the adhesive is retained in the lower groove portions 120 and 220, and the lower groove portions 120 and 220 cannot be seen from the outside. Thus, it is possible to improve the appearance while reducing the protrusion of the adhesive, and it is possible to attach the first member 310 and the second member 320, which are the mounting members, to the key base member 300 satisfactorily. In addition, it is possible to reduce the possibility that the adhesive protrudes and drips from the opened lower surfaces 310b, 321b, 322b of the first member 310 and the second member 320, thereby preventing contamination in the vicinity of the white key 30.

Further, the key base member 300 has the wide portion 301a having a first width in the key arrangement direction LR on the top surface (upper surface 301p) and the narrow portion 301b having a second width narrower than the first width. The lower groove portions 120 and 220 (front lower groove portions 121 and 221) are provided on the first side surface 303L1 and the second side surface 304R2 opposite to the first side surface 303L1, respectively, in the wide portion 301a. The distance from the top surface to the lower groove portion 120 (front lower groove portion 121) of the first side surface 303L1 and the distance from the top surface to the lower groove portion 220 (front lower groove portion 221) are different. As a result, even in the case of the key base member 300 in which the lengths (QL2, QR2) of the first side surface 303L1 and the second side surface 304R2 in the vertical direction are different, such as the C key, the mounting member can be attached satisfactorily.

In addition, the key base member 300 has the upper groove portions 110 and 210 provided along the longitudinal direction of the key on the upper sides of the side surfaces 303L and 304R, which are invisible from the outside when the mounting member is attached. As a result, the adhesive can be stored on the upper surface side of the first member 310 and the second member 320, and the protrusion of the adhesive Z from between the mounting member and the lower surface 301q of the top plate 301 can be reduced. The upper groove portions 110 and 210 are also invisible from the outside, and the mounting member can be satisfactorily attached on the key base member 300.

Also, the volume of the lower groove portions 120, 220 is larger than the volume of the upper grooves 110, 210. As a result, on the upper surface sides of the first member 310 and the second member 320, the adhesive goes beyond the front upper groove portions 111 and 211 of the upper groove portions 110 and 210 and enters between the lower surface 301q of the upper projecting portion 301d and the upper surfaces 310a and 321a, and on the lower side, the adhesive is stored in the front lower groove portions 121 and 221 of the lower groove portions 120 and 220 so as to reduce the protrusion of the adhesive to the opened lower surfaces 310b and 321b.

Also, the vertical width W2 of the lower groove portions 120, 220 is greater than the vertical width W1 of the upper groove portions 110, 210. As a result, the volume of the lower groove portions 120 and 220 can be easily made larger than the volume of the upper groove portions 110 and 210 while reducing the effect of molding with the resin material by making the depths the same.

Further, the key base member 300 has mounting member receiving portions such as the projecting plates 306 and 307 projecting in the key arrangement direction LR at locations corresponding to the lower surfaces 310b, 321b and 322b of the first member 310 and the second member 320. As a result, it is possible to prevent the wooden member from falling into the case 20 in the unlikely event that the wooden member falls.

The key base member 300 also has the upper protruding portions 301d that protrude in the key arrangement directions and cover the upper surfaces 310a, 321a, and 322a of the mounting members, and leaves at least a portion of the lower surfaces 310b, 321b, and 322b of the mounting members open. As a result, for example, when the mounting members are made of a wood grain member or a wooden member, it is possible to make it look as if the entire key is made of the wooden member, and the key can be made to have a good appearance.

Further, the key base member 300 has the contact surfaces 175, 275 with the mounting members on the lower side of the lower groove portions 120, 220. As a result, the sense of unity between the key base member 300 and the mounting members can be enhanced, and the key can be made to look better.

Also, the mounting member may include at least one of a wooden member and a woodgrain member. Thus, it is possible to provide a keyboard instrument having keys whose keys can be seen like a real piano, and whose mounting members are satisfactorily attached to the key base members while reducing the protrusion of the adhesive.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A keyboard instrument, comprising a plurality of keys,
wherein each key includes a mounting member and a key base member to which the mounting member is attached on a side surface thereof, and
wherein the key base member has, on a lower side of the side surface, a lower groove portion that cannot be seen from the outside when the mounting member is attached thereto.

2. The keyboard instrument according to claim 1,
wherein the key base member has a wide portion having a first width in a key arrangement direction at a top surface of the key base member and a narrow portion having a second width at the top surface that is narrower than the first width,
wherein the lower groove portion is provided on each of a first side surface of the wide portion and a second side surface of the wide portion opposite to the first side surface, and
wherein a distance from the top surface to the lower groove portion on the first side surface and a distance from the top surface to the lower groove portion on the second side surface are different.

3. The keyboard instrument according to claim 1, wherein the key base member has an upper groove portion provided on an upper side of the side surface extending in a longitudinal direction of the key and invisible from the outside when the mounting member is attached.

4. The keyboard instrument according to claim 3, wherein a volume of the lower groove portion is larger than a volume of the upper groove portion.

5. The keyboard instrument according to claim 4, wherein a vertical width of the lower groove portion is greater than a vertical width of the upper groove portion.

6. The keyboard instrument according to claim 1, wherein the key base member has a mounting member receiving portion projecting in a key arrangement direction at a location corresponding to a lower surface of the mounting member.

7. The keyboard instrument according to claim 1, wherein the key base member includes an upper protruding portion that protrudes in a key arrangement direction and covers an upper surface of the mounting member, leaving at least a portion of a lower surface of the mounting member open.

8. The keyboard instrument according to claim 1, wherein the key base member has a contact surface with the mounting member on a lower side of the lower groove portion.

9. The keyboard instrument according to claim 1, wherein the mounting member includes at least one of a wooden member and a woodgrain member.
